(19) United States
(12) Patent Application Publication
(10) Pub. No.: US 2011/0319145 A1
(43) Pub. Date: Dec. 29, 2011

(54) PORTABLE ELECTRONIC DEVICE WITH DETACHABLE ANTENNA

(75) Inventor: CHIN-HUNG MA, Taoyuan (TW)

(73) Assignee: FOXCONN COMMUNICATION TECHNOLOGY CORP., Taoyuan County (TW)

(21) Appl. No.: 13/085,436

(22) Filed: Apr. 12, 2011

(30) Foreign Application Priority Data
Jun. 23, 2010 (TW) 99120343

(51) Int. Cl. H04M 1/02

(52) U.S. Cl. 455/575.7

(57) ABSTRACT

A portable electronic device includes a housing and an antenna. The housing includes at least one magnetic portion. The antenna includes at least one mounting end corresponding to the at least one magnetic portion. The at least one mounting end is magnetically attracted by the at least one magnetic portion and attached on the at least one magnetic portion.

### BACKGROUND

1. Technical Field

The disclosure generally relates to portable electronics devices, and particularly to a portable electronic device with a detachable antenna.

2. Description of Related Art

Antennas are important components of portable electronic devices such as mobile phones and personal digital assistants (PDAs) and are used for transmitting and receiving signals. Generally, the antennas are installed on the portable electronic devices with screws or rivets, which may be inconvenient. In addition, the antennas cannot be detached from portable electronic device once the antennas are secured. It is impossible for a user to remove the antennas even if the antenna is not being used.

Therefore, there is room for improvement within the art.

### BRIEF DESCRIPTION OF THE DRAWINGS

Many aspects of the present embodiment can be better understood with reference to the following drawings. The components in the drawings are not necessarily drawn to scale, the emphasis instead being placed upon clearly illustrating the principles of the present embodiment.

FIG. 1 is a disassembled view of a portable electronic device with a detachable antenna, according to a first exemplary embodiment.

FIG. 2 is an assembled view of the portable electronic device of FIG. 1.

FIG. 3 is similar to FIG. 2, but showing the antenna rotated to another angle relative to a housing.

FIG. 4 is a disassembled view of a portable electronic device with a detachable antenna, according to a second exemplary embodiment.

FIG. 5 is an assembled view of the portable electronic device of FIG. 4.

FIG. 6 is a disassembled view of a portable electronic device with a detachable antenna, according to a third exemplary embodiment.

FIG. 7 is an assembled view of the portable electronic device of FIG. 6.

FIG. 8 is similar to FIG. 7, but showing the antenna received in a recess portion.

FIG. 9 is a disassemble view of a portable electronic device with a detachable antenna, according to a fourth exemplary embodiment.

FIG. 10 is an assembled view of the portable electronic device of FIG. 9.

FIG. 11 is a disassemble view of a portable electronic device with a detachable antenna, according to a fifth exemplary embodiment.

FIG. 12 is an assembled view of the portable electronic device of FIG. 11.

FIG. 13 is similar to FIG. 12, but showing the antenna received in a receiving slot.

FIG. 14 is a disassembled view of an antenna of the portable electronic device of FIG. 12, according to another embodiment.

FIG. 15 is an assembled view of the antenna of FIG. 14.

### DETAILED DESCRIPTION

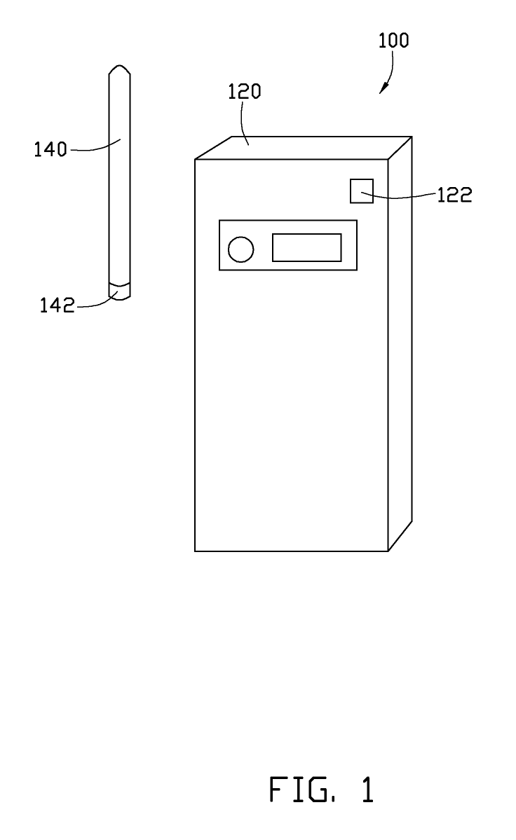

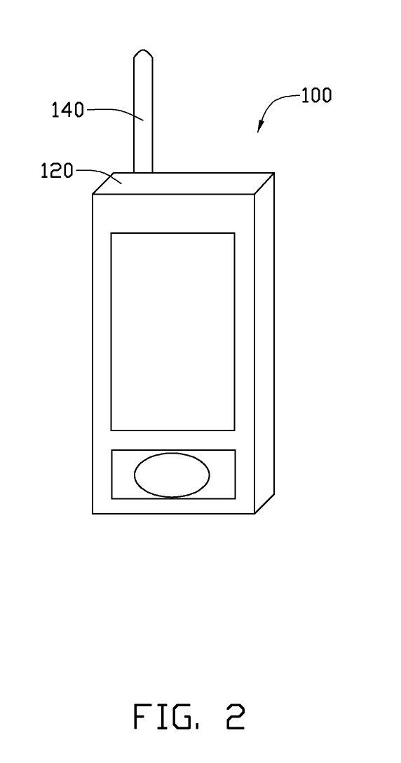

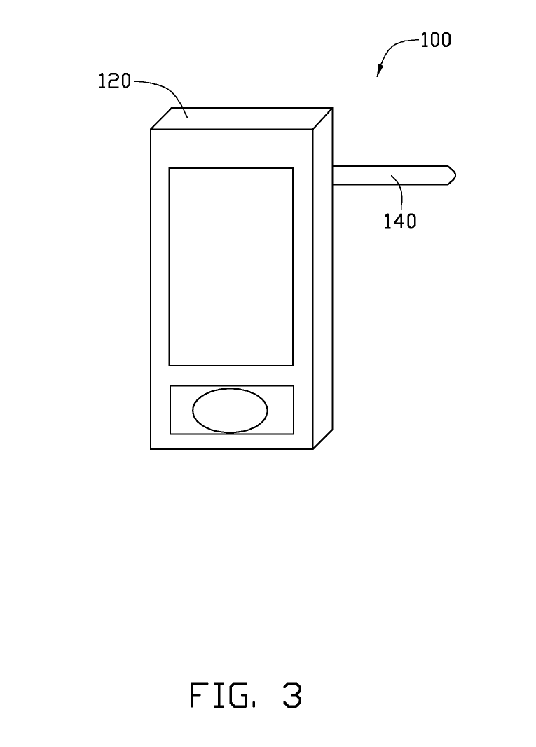

Referring to FIGS. 1 and 2, a portable electronic device 100, according to a first exemplary embodiment, includes a housing 120 and an antenna 140 magnetically attached to the housing 120. The portable electronic device 100 may be a mobile phone, or a personal digital assistant (PDA). A magnetic portion 122 is formed on the housing 120. The antenna 140 is metallic and includes a mounting end 142. The mounting end 142 can be attracted by the magnetic portion 122 and attached to the magnetic portion 122. Also referring to FIG. 3, the antenna 140 can be rotated at the magnetic portion 122 to change an angle between the antenna 140 and the housing 120, thereby allowing the adjustment of signal receiving quality of the antenna 140. The mounting end 142 may be served as a feeding end of the antenna 140. When the antenna 140 is attached on the housing 120, the portable electronic device 100 can communicate with other devices using the antenna 140.

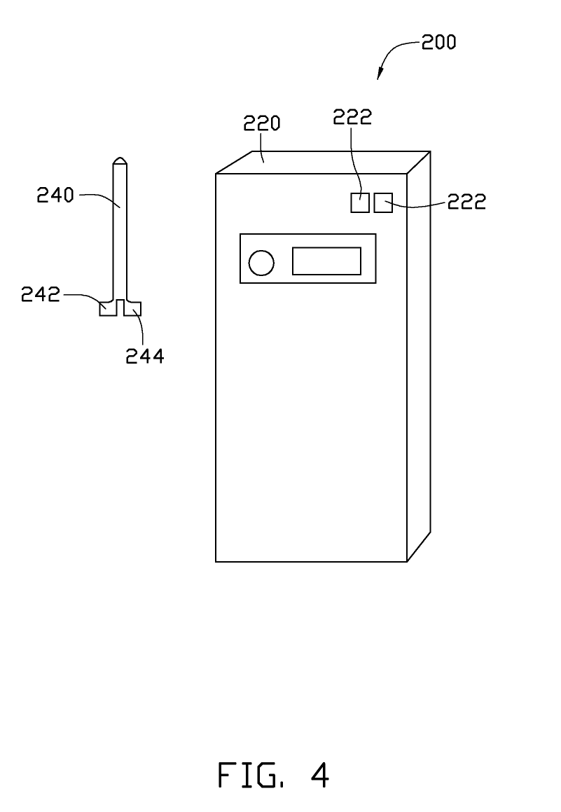

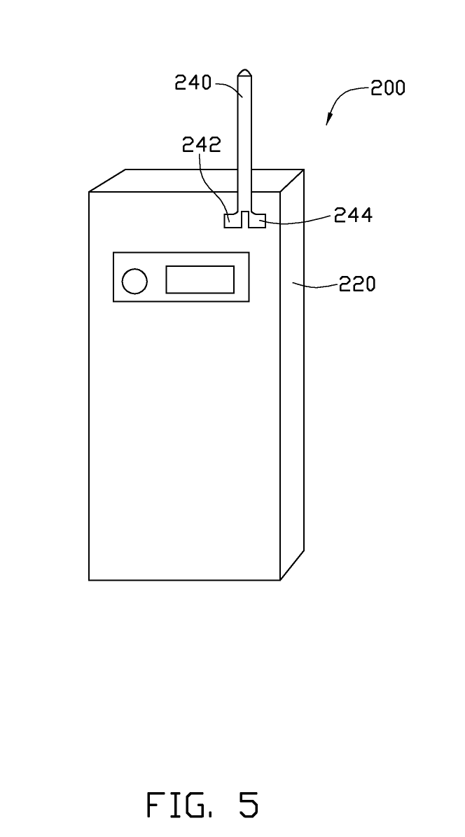

Referring to FIGS. 4 and 5, a portable electronic device 200, according to a second exemplary embodiment, includes a housing 220 and an antenna 240. Two opposite magnetic portions 222 are formed on one side of the housing 220. The antenna 140 is metallic and includes two mounting ends 242, 244 symmetrically extended at one end thereof. The mounting ends 242, 244 correspond to the two magnetic portions 222 and can be respectively attached on the magnetic portions 222 to mount the antenna 240 to the housing 220. The mounting ends 242, 244 may be served as a feeding end and a ground end of the antenna 240.

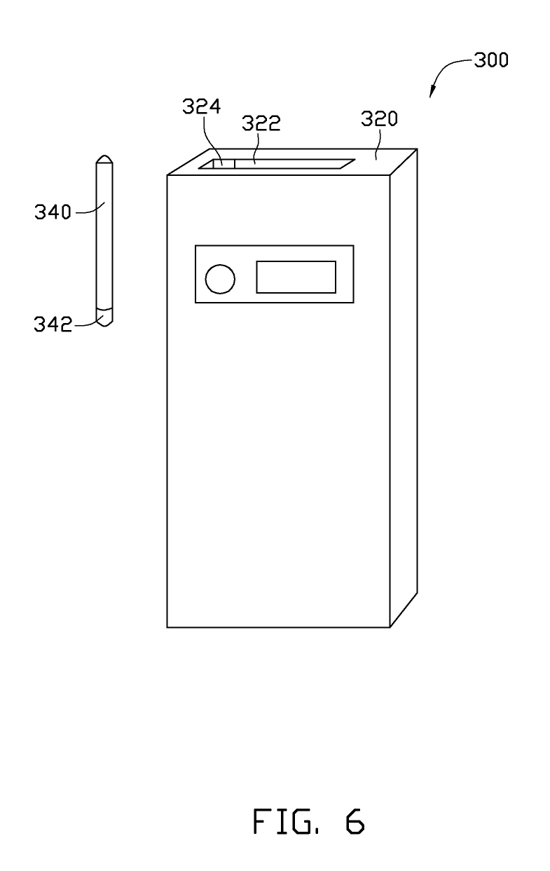

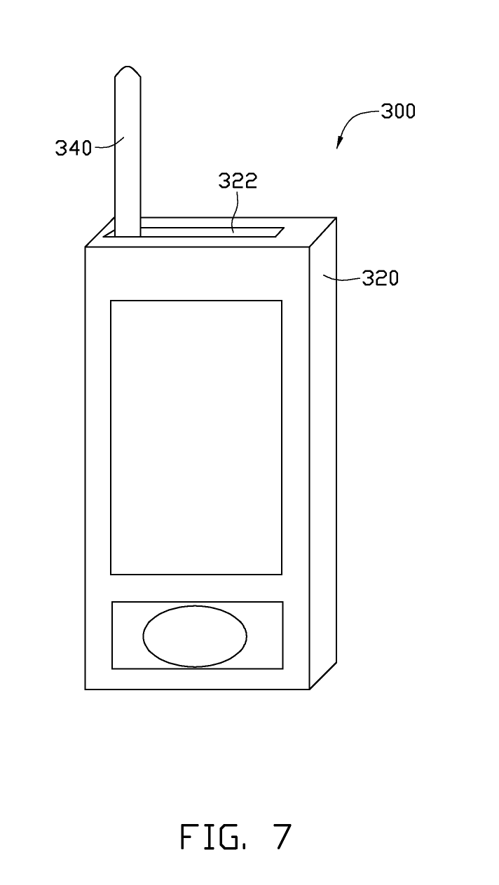

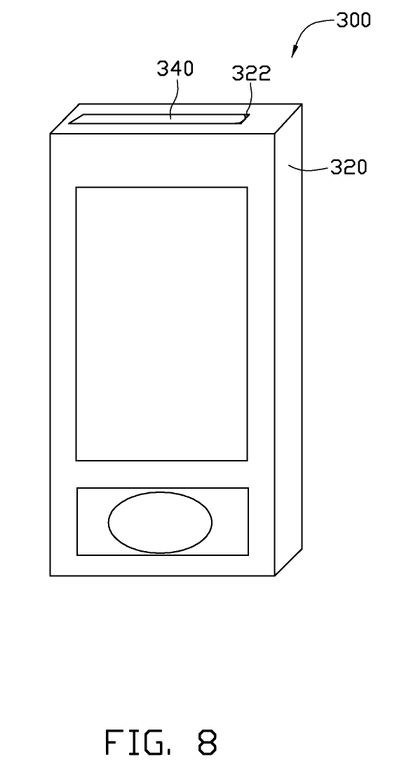

Referring to FIGS. 6 and 7, a portable electronic device 300, according to a third embodiment, includes a housing 320 and an antenna 340. A recess portion 322 is defined in the housing 320. A magnetic portion 324 is formed on one side of the recess portion 322. The antenna 340 is metallic and includes a mounting end 342. The mounting end 342 can be attached on the magnetic portion 324 to mount the antenna 340 on the housing 320. Also referring to FIG. 8, the antenna 340 can be rotated on the magnetic portion 324 and can be received in the recess portion 322.

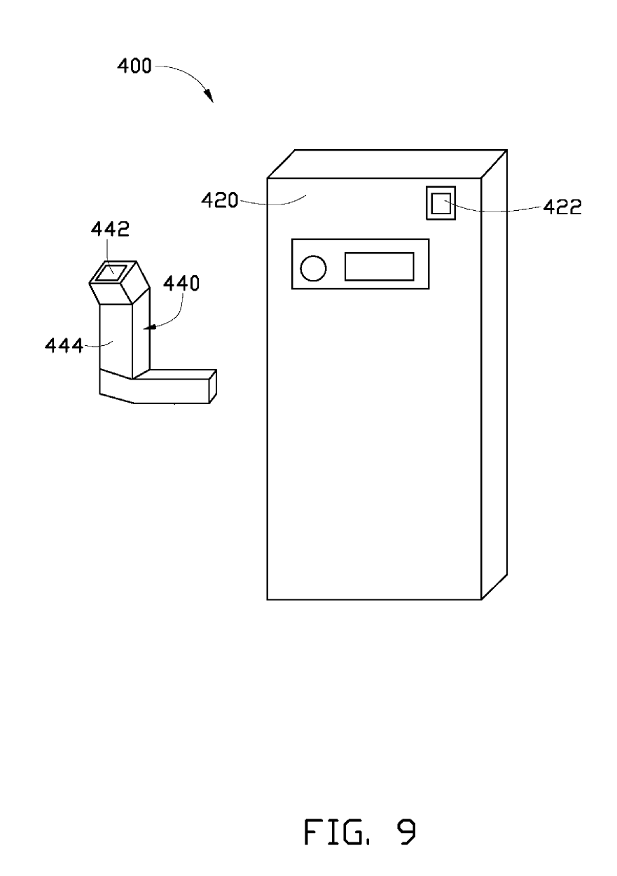

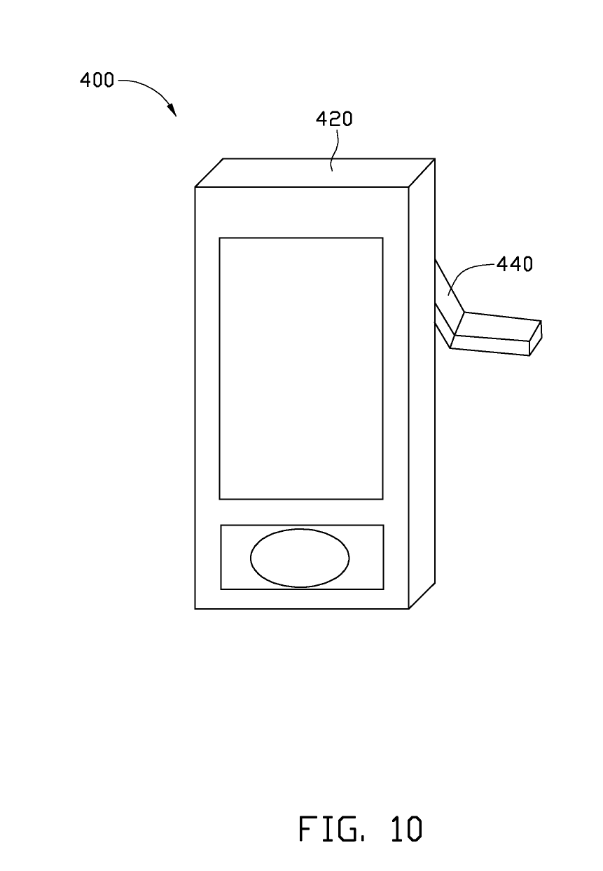

Referring to FIG. 9, a portable electronic device 400, according to fourth exemplary embodiment, includes a housing 420 and an antenna 440. A magnetic portion 422 is formed on the housing 420. The antenna 440 is metallic and includes a mounting end 442 and a main body 444. The mounting end 442 may be served as a feeding end of the antenna 140. The main body 444 is substantially L-shaped. The mounting end 442 is extended from one end of the main body 444 The mounting end 442 can be attached on the magnetic portion 422 to mount the antenna 440 on the housing 420. Also referring to FIG. 10, the mounting end 420 can be rotated on the magnetic portion 422, and the main body 444 can be used to support the housing 420 on a desk. Thus, it is convenient to view images or videos from the portable electronic device 100.

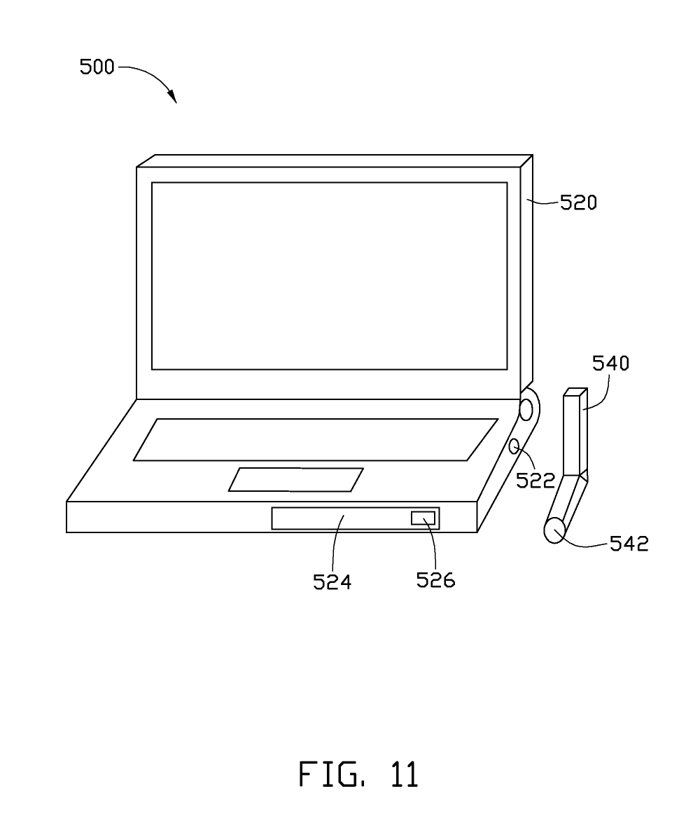

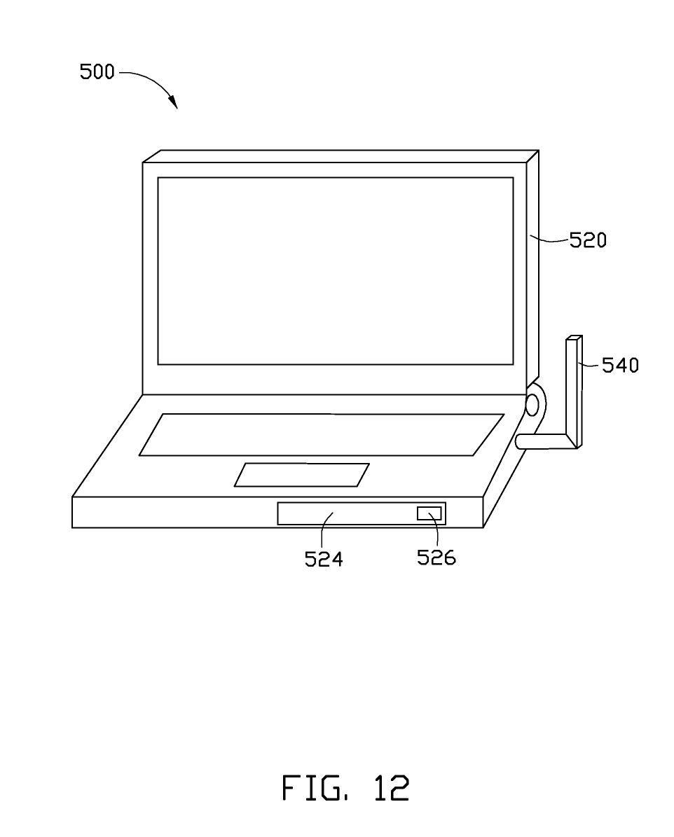

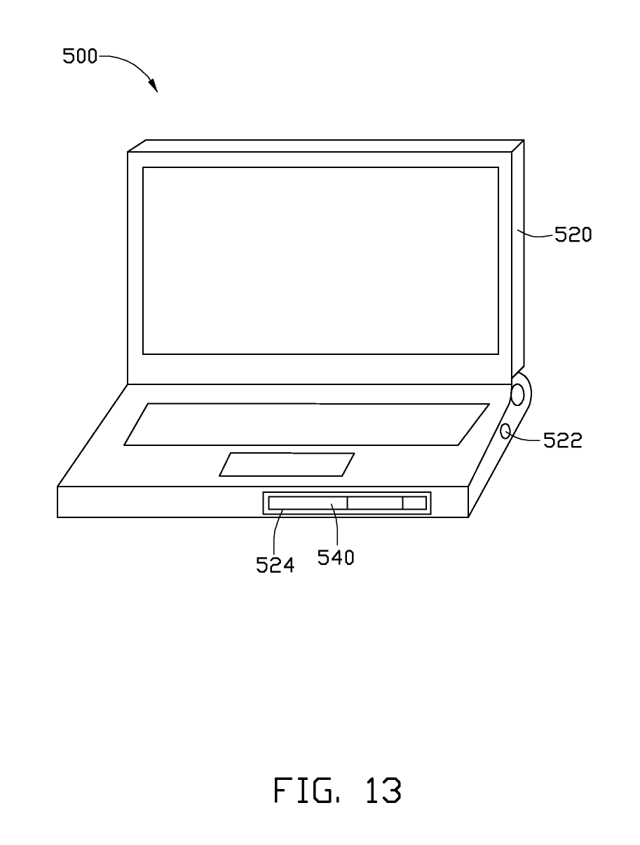

Referring to FIGS. 11 and 12, a portable electronic device 500, which may be a notebook computer, according to fifth exemplary embodiment, includes a housing 520 and an antenna 540. A magnetic portion 522 is formed on one side of the housing 520. A receiving slot 524 is defined in another side of the housing 520. A positioning portion 526 is magnetic and formed on a bottom of the receiving slot 524. The antenna 540 is metallic and substantially L-shaped. A mounting end 542 is formed at one end of the antenna 540. The mounting end 542 may be served as a feeding end of the antenna 540. In use, the mounting end 542 can be attached on the magnetic portion 522 to mount the antenna 540 on the housing 520. Also referring to FIG. 13, when not in use, the antenna 540 can be folded and can be received in the receiving slot 524. The mounting end 542 is attracted by the positioning portion 526 and thereby securing the antenna 540 in the receiving slot 524.

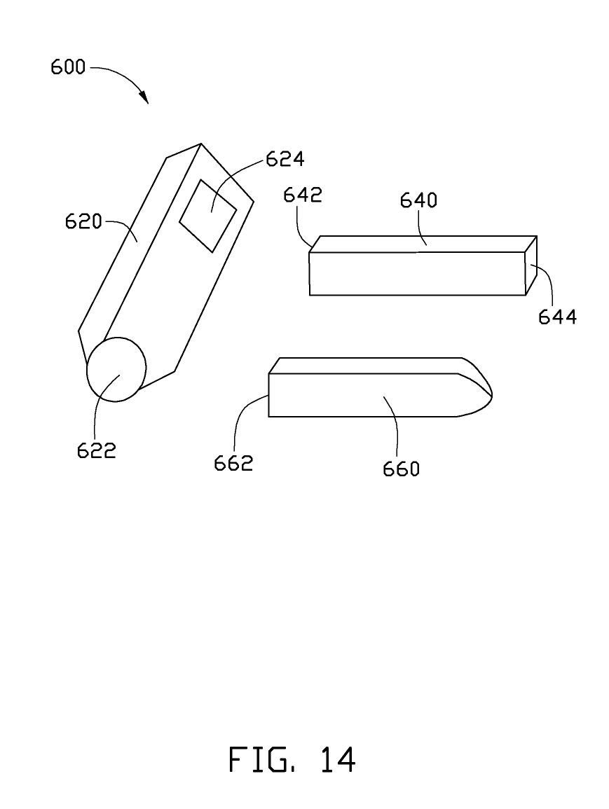

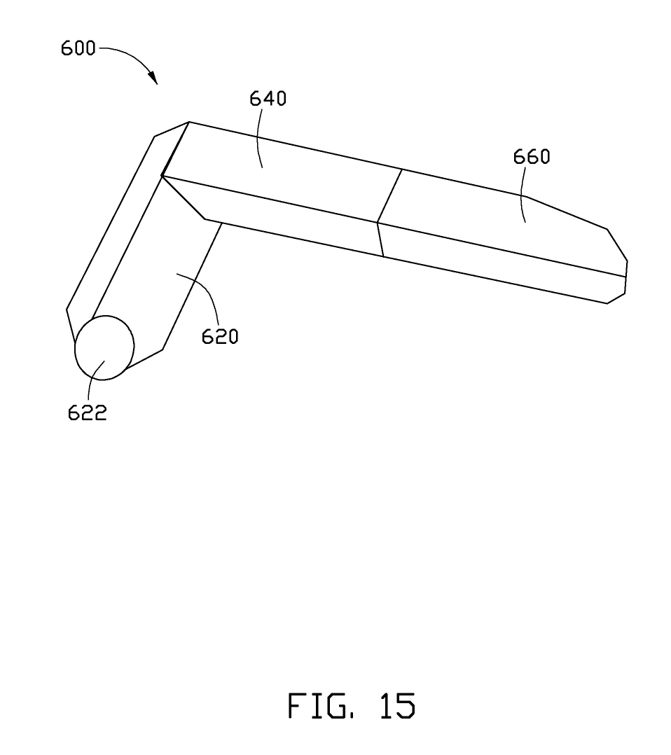

Referring to FIGS. 14 and 15, in other embodiments, the portable electronic device 500 may include an antenna 600. The antenna 600 includes a first section 620, a second section 640 and a third section 660. The first section 620 includes a first magnetic end 622 and a second magnetic end 624 respectively set two ends thereof. The second section 640 includes a third magnetic end 642 and a fourth magnetic end 644 respectively set at two ends thereof. The third section 660 includes a fifth magnetic end 662 set at one end thereof. The fifth magnetic end 662 can be attached to the fourth magnetic end 644, and the third magnetic end 622 can be attached to the second magnetic end 624. The first magnetic end 622 is substantially similar to the mounting end 542 of the antenna 540. Therefore, the first section 620, the second section 640, and the third section 660 can be assembled together to form the antenna 600 and can be conveniently detached.

The magnetic portions 122, 222, 324, 424 and 522, the positioning portion 526, the first to fifth magnetic ends 622 624, 642, 644 and 662 can be formed by a magnetizing process or by overlaying magnetic material thereon.

The antenna can be assembled to the portable electronic device conveniently by magnetic force between the mounting end and the magnetic portion. In addition, the antenna can be detached from the housing when it is not used.

It is believed that the exemplary embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. A portable electronic device, comprising:
a housing defining at least one magnetic portion; and
an antenna including at least one mounting end corresponding to the at least one magnetic portion; wherein the at least one mounting end is magnetically attracted by the at least one magnetic portion and attached on the at least one magnetic portion.

2. The portable electronic device as claimed in claim 1, wherein the antenna includes a mounting end, the mounting end is attached on the at least one magnetic portion and serves as a feeding end.

3. The portable electronic device as claimed in claim 2, wherein the antenna can be rotated about the magnetic portion to change an angle between the antenna and the housing.

4. The portable electronic device as claimed in claim 1, wherein the housing includes two magnetic portions, the antenna includes two mounting ends, the mounting ends are respectively attached on the magnetic portions and served as a feeding end and ground end.

5. The portable electronic device as claimed in claim 2, wherein the housing further includes a recess portion, the magnetic portion is formed at the recess portion, the antenna can be rotated about the magnetic portion and received in the recess portion.

6. The portable electronic device as claimed in claim 2, wherein the antenna includes a mounting end and a main body, the mounting end can be attached on the magnetic portion, the main body can be served as a support for the housing.

7. The portable electronic device as claimed in claim 6, wherein the main body is L-shaped.

8. The portable electronic device as claimed in claim 2, wherein the magnetic portion is formed on one side of the housing, the housing further includes a receiving slot defined in another side of the housing, the antenna can be received in the receiving slot.

9. The portable electronic device as claimed in claim 2, wherein the housing further includes a positioning portion formed on the bottom of the receiving slot, the positioning portion attracts and secures the mounting end when the antenna is received in the slot.

10. The portable electronic device as claimed in claim 9, wherein the antenna is L-shaped and foldable.

11. The portable electronic device as claimed in claim 2, wherein the antenna includes a first section, a second section, and a third section; the first section includes a first magnetic end and a second magnetic end respectively set two ends; the second section includes a third magnetic end and a fourth magnetic end respectively set two ends; the third section includes a fifth magnetic end set one end; the first magnetic end is served as the mounting end, the second magnetic end is attached on the third magnetic end, the fourth magnetic end is attached on the fourth magnetic end.
